(19) United States
(12) Patent Application Publication
(10) Pub. No.: US 2023/0060475 A1
(43) Pub. Date: Mar. 2, 2023

(54) OPERATION DATA ANALYSIS DEVICE, OPERATION DATA ANALYSIS SYSTEM, AND OPERATION DATA ANALYSIS METHOD

(71) Applicant: Hitachi, Ltd., Tokyo (JP)

(72) Inventors: Koji AMANO, Tokyo (JP); Tsunehiko BABA, Tokyo (JP); Toru SHIMOTORI, Tokyo (JP)

(21) Appl. No.: 17/678,277

(22) Filed: Feb. 23, 2022

(30) Foreign Application Priority Data
Sep. 2, 2021 (JP) 2021-142985

(51) Int. Cl. G06F 9/30; G06F 9/345

(52) U.S. Cl. CPC G06F 9/3001; G06F 9/345

(57) ABSTRACT

According to the invention, operation data is analyzed at a higher level. Provided is an operation data analysis device including an arithmetic device and a storage device. The storage device stores management target data including operation data which is data related to an operation. The arithmetic device analyzes how the operation data is used in the operation by using the operation data included in the management target data and operation data used in a structure related to management of the management target data.

### CROSS-REFERENCE TO RELATED APPLICATION

The present application claims priority from Japanese application JP2021-142985, filed on Sep. 2, 2021, the contents of which is hereby incorporated by reference into this application.

### BACKGROUND OF THE INVENTION

### 1. Field of the Invention

The present invention relates to an operation data analysis device, an operation data analysis system, and an operation data analysis method.

### 2. Description of the Related Art

In the related art, there is a technique described in JP-A-2018-72960 regarding analysis of operation data. This publication describes that “A data analysis support device includes: a relation network generation unit that analyzes a relation between operation systems, a relation between operation data tables, a relation between data items which have the respective operation data tables, and a relation between data values which have records of the respective operation data tables, and stores the relations as a relation network; a data item classification unit that classifies data items to be analyzed into a first data type based on an actual value and a second data type based on a planned value or pre-definition; an analysis data table generation unit that generates and accumulates a data analysis table to be used for data analysis; a data model generation unit that generates, as a data model, a group of the data item which can be combined and can be analyzed; and an analysis target item presentation unit that recommends a data item to be analyzed”.

In the related art, even a person who has no data knowledge or a person who has no field knowledge can easily select and analyze an target item to be analyzed without using table definition information. However, in order to perform the analysis at a higher level, how operation data is used in an operation is important. For example, when a term related to a certain operation is analyzed, it is desirable not only to analyze data created including the term, but also to analyze the data in consideration of clarified meaning, versatility, and the like of the term for persons involved in the operation.

### SUMMARY OF THE INVENTION

Therefore, an object of the invention is to provide an operation data analysis technique capable of analyzing operation data at a higher level.

In order to achieve the above-described object, an example of an operation data analysis device and an operation data analysis system of the invention includes an arithmetic device and a storage device. The storage device stores management target data including operation data which is data related to an operation. The arithmetic device analyzes how the operation data is used in the operation by using the operation data included in the management target data and operation data used in a structure related to management of the management target data.

An example of an operation data analysis method of the invention includes: by an arithmetic device, a step of storing, in a storage device, management target data including operation data which is data related to an operation; a step of analyzing how the operation data is used in the operation by using the operation data included in the management target data and operation data used in a structure related to management of the management target data; and a step of outputting an analysis result.

According to the invention, it is possible to provide an operation data analysis technique capable of analyzing operation data at a higher level. Problems, configurations, and effects other than those described above will be clarified by the following description of embodiments.

### BRIEF DESCRIPTION OF THE DRAWINGS

FIG. 1 is an explanatory diagram of a configuration of an operation data analysis system.

FIG. 2 is an explanatory diagram of a process performed by the operation data analysis system (part 1).

FIG. 3 is an explanatory diagram of the process performed by the operation data analysis system (part 2).

FIG. 4 is a flowchart showing an outline of the processes of the operation data analysis system.

FIG. 5 is a specific example of an integration screen for management of a meaning of data.

FIG. 6 is an explanatory diagram for creating a dictionary of the meaning of data (part 1).

FIG. 7 is an explanatory diagram for creating a dictionary of the meaning of data (part 2).

FIG. 8 is an explanatory diagram for creating a dictionary of the meaning of data (part 3).

FIG. 9 is an explanatory diagram of steps of a term distance analysis algorithm.

FIG. 10 is a configuration diagram in a case of analyzing an operation of a user.

FIG. 11 is an explanatory diagram of redefinition of a structured ID based on an implementation-dependent semantic hierarchy.

FIG. 12 is an explanatory diagram of redefinition of a structured ID based on a semantic hierarchy of a database.

FIG. 13 is an explanatory diagram of extraction of a semantic relation.

FIGS. 14A and 14B show a procedure for generating a structured ID.

FIG. 15 is a flowchart of generation of a data semantic relation based on an operation of a user.

FIG. 16 is an explanatory diagram of a generation result of the data semantic relation based on the operation of the user.

FIGS. 17A and 17B show a procedure for analyzing a density.

FIG. 18 is an explanatory diagram of an analysis result of the density.

FIG. 19 is a flowchart showing a procedure for acquiring a meaning of structured data based on a sentence of a file.

FIG. 20 is an explanatory diagram of governance management of the meaning of data (part 1).

FIG. 21 is an explanatory diagram of the governance management of the meaning of data (part 2).

FIG. 22 is an explanatory diagram of the governance management of the meaning of data (part 3).

FIG. 23 is a flowchart showing a procedure for creating a template for understanding the meaning of data.

FIG. 24 is a flowchart showing a procedure for automatically updating a management template.

### DESCRIPTION OF THE PREFERRED EMBODIMENTS

Hereinafter, embodiments of the invention will be described with reference to the drawings.

In the present specification and drawings, elements that have substantially the same function or configuration are denoted with the same reference numerals, and duplicate explanation thereof is omitted.

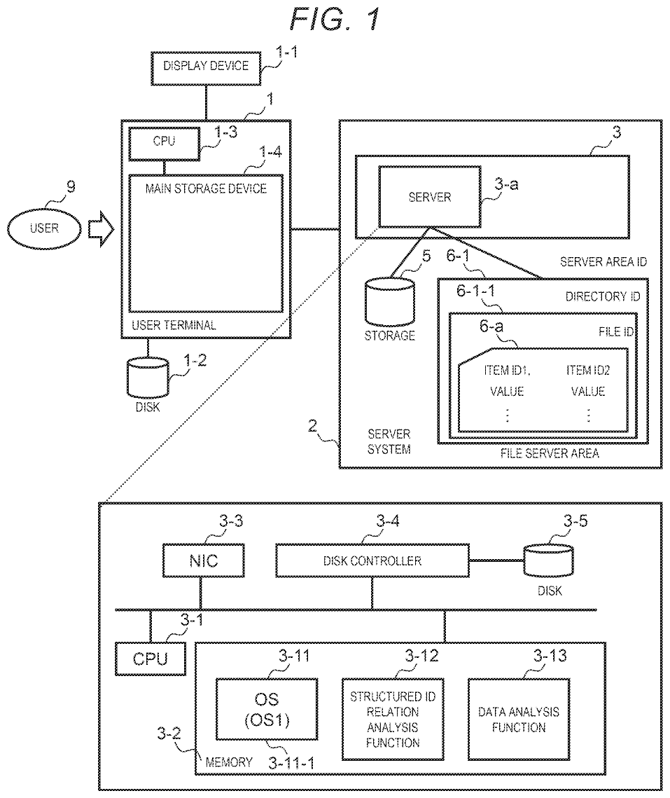

FIG. 1 is an explanatory diagram of a configuration of an operation data analysis system.

The operation data analysis system includes a user terminal 1 and a server system 2 as an operation data analysis device.

The user terminal 1 is a computer including a central processing unit (CPU) 1-3 and a main storage device 1-4 therein, and peripheral devices such as a display device 1-1 and a disk 1-2 which is an auxiliary storage device are connected to the user terminal 1.

The user terminal 1 receives an operation of a user 9, stores management target data including operation data in the server system 2, and conducts operation using the management target data.

The server system 2 includes one or more servers 3 and one or more storages 5.

The storage 5 is a storage device that stores management target data and the like. The server 3 generates a file server area having a hierarchical structure in a memory thereof or the storage 5, and stores the management target data. The server system 2 uses a name assigned to each hierarchy as a type of operation data, and analyzes the operation data by using a hierarchical structure as hierarchized identification information (structured ID).

In FIG. 1, a directory 6-1-1 is generated under a server area 6-1, and a file 6-a, which is management target data, is stored under the directory 6-1-1.

In this case, a server area ID of the server area 6-1, a directory ID of the directory 6-1-1, and a file name of the file 6-a are each a type of operation data, and the “server area ID/directory ID/file name” is identification information (structured ID).

Item IDs and values included in the file 6-a are also the operation data.

Here, a configuration of the server 3 will be described by using a server 3-a which is one of the servers 3 as an example. The server 3 includes a CPU 3-1 as an arithmetic device, a memory 3-2 as a main storage device, a network interface card (NIC) 3-3, a disk controller 3-4, and a disk 3-5 as an auxiliary storage device.

The CPU 3-1 loads programs and data into the memory 3-2 and sequentially executes the programs to implement various functions.

Specifically, in the memory 3-2, data related to an operating system (OS) 3-11, a structured ID relation analysis function 3-12, a data analysis function 3-13, and the like is loaded.

The OS 3-11 is a group of programs for controlling a basic operation of the server 3.

The structured ID relation analysis function 3-12, the data analysis function 3-13, and the like perform a process of analyzing how operation data is used in the operation by using the operation data included in management target data and operation data used in a structure related to management of the management target data.

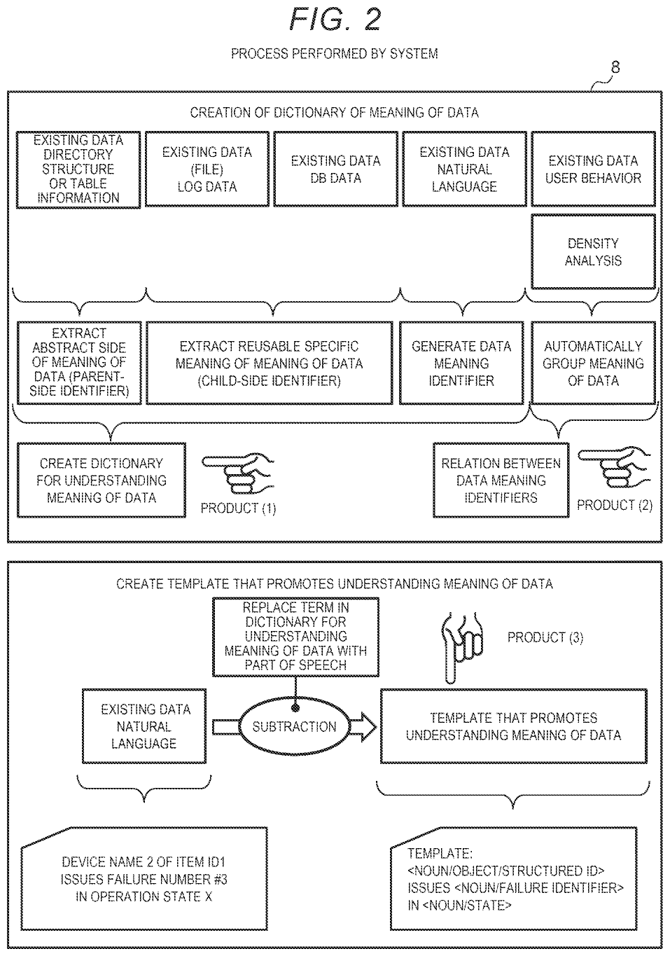

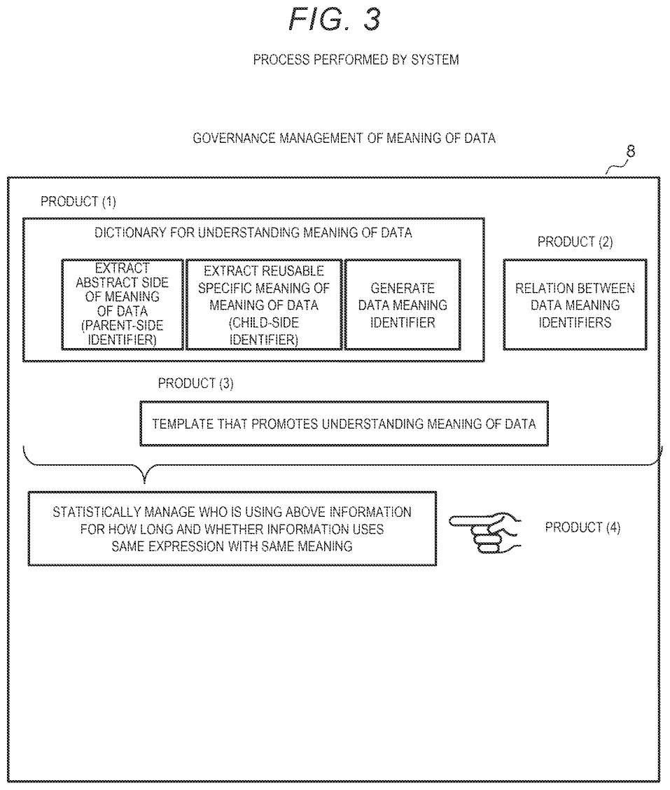

FIGS. 2 and 3 are explanatory diagrams of a process performed by the operation data analysis system. As shown in FIGS. 2 and 3, the process performed by the operation data analysis system includes “creation of a dictionary of a meaning of data”, “creation of a template that promotes understanding the meaning of data”, and “governance management of the meaning of data”.

First, the creation of a dictionary of the meaning of data will be described.

The server 3 extracts, from a directory structure and table information of the existing data, an abstract side of the meaning of data as a parent-side identifier. As the parent-side identifier, names of hierarchies up to where management target data is stored, a name of the management target data, and terms used for items and values of tables are extracted.

It is highly likely that the terms used for the hierarchies, data, items, values, and the like are recognized as sufficiently general and clear terms for persons involved in the operation (persons involved in operation). The terms used in the hierarchies, data, items, values, and the like have little inconsistency in notation, and are highly likely to be related to operation. Therefore, it is considered effective to analyze terms used for management of management target data as operation data.

The server 3 further extracts a reusable specific meaning of the meaning of data as a child-side identifier from the existing data such as log data and DB data. This is because the data included in the log data or the DB data is highly likely to be terms directly related to an operation.

The server 3 generates a data meaning identifier from the natural language of the existing data. For example, sentence data described in the natural language, such as an operation manual, includes various terms related to an operation. Therefore, words extracted from the natural language can be used as data meaning identifiers.

The server 3 creates a dictionary for understanding the meaning of data by registering the parent-side identifier, the child-side identifier, and the data meaning identifier. The dictionary for understanding the meaning of data is a first product of the operation data analysis system.

The server 3 automatically groups the meaning of data by analyzing a density with respect to behaviors of the user (person involved in operation) with respect to the existing data, and obtains a relation between the data meaning identifiers. The relation between the data meaning identifiers is a second product of the operation data analysis system. The analysis of the density will be described later.

Next, the creation of a template that promotes understanding the meaning of data will be described.

The server 3 uses the remaining terms after extracting the terms from the natural language of the existing data as a template that promotes understanding the meaning of data. The template is a third product of the operation data analysis system.

Specifically, the server 3 performs a process of generalizing the terms registered in the dictionary for understanding the meaning of data, that is, a process of replacing the terms registered in the dictionary with parts of speech, on a sentence described in natural language.

For example, if an original sentence is “a device name 2 of an item ID1 issues a failure number #3 in an operation state X” and “the device name 2 of the item ID1”, “the operation state X”, and “the failure number #3” are registered in the dictionary, the template is as follows.

“The <noun/object/structured ID> issues the <noun/failure identifier> in the <noun/state>”.

Next, the governance management of the meaning of data will be described.

The server 3 uses the first to third products (the dictionary for understanding the meaning of data, the relation between the data meaning identifiers, and the template that promotes understanding the meaning of data) to statistically manage “who is using” each piece of information “for how long” and “whether” each piece of information “uses the same expression with the same meaning”. A result of the statistic is a fourth product, and can be used to manage employment of the operation data by unifying the terms of directory names and file names or making an announcement to a person involved in operation, for example.

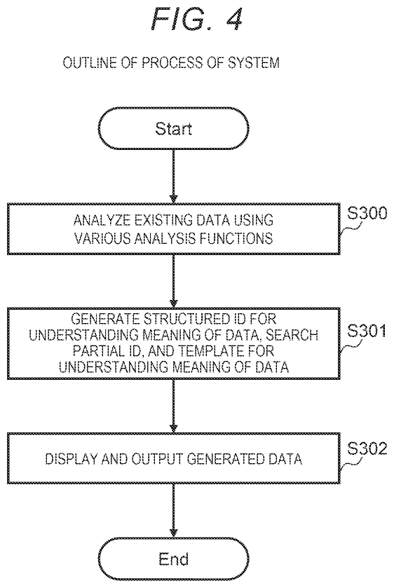

FIG. 4 is a flowchart showing an outline of the process of the operation data analysis system.

Prior to the present process, the server 3 executes a step of storing management target data including the operation data in the storage 5 or the like.

Then, the server 3 analyzes the existing data using various analysis functions (step 300). Then, the server 3 generates, based on a result of the analysis, a structured ID for understanding the meaning of data, a search partial ID, and a template for understanding the meaning of data (step 301). The generated data indicates how the operation data is used in the operation, and the generated data is displayed and output as an analysis result (step 302), and the process ends.

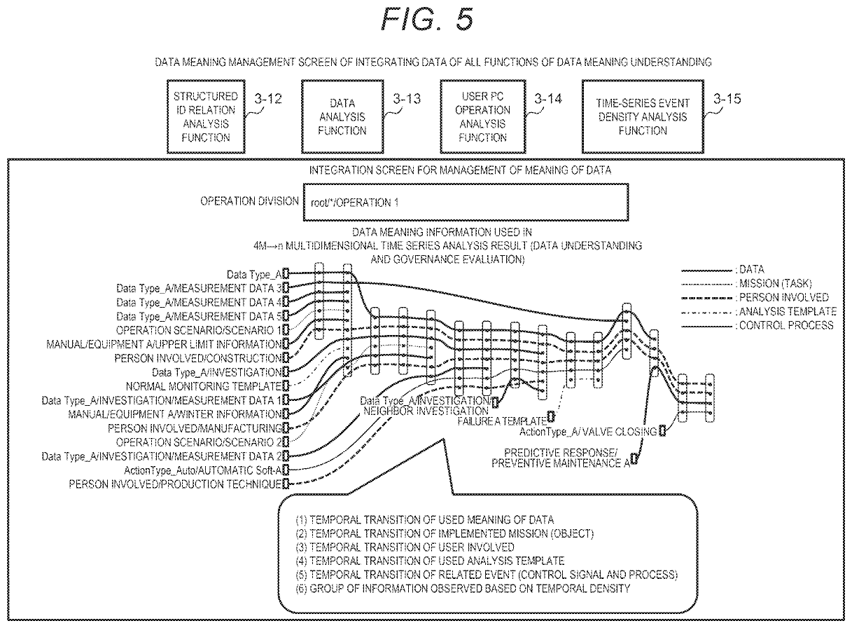

FIG. 5 is a specific example of an integration screen for management of the meaning of data.

The integration screen shown in FIG. 5 is a screen for integrating and displaying analysis results of a user PC operation analysis function 3-14 and a time-series event density analysis function 3-15 in addition to the structured ID relation analysis function 3-12 and the data analysis function 3-13.

In the integration screen shown in FIG. 5, data related to a designated operation division “root/*/operation 1” is displayed. Here, by using the wild card “*”, the data related to the operation 1 can be to be analyzed even when managed by different departments, for example.

In the integration screen, the following temporal transitions are displayed as the length of the horizontal axis.

(1) Temporal transition of used meaning of data

(2) Temporal transition of implemented mission (object)

(3) Temporal transition of user involved (person involved in operation)

(4) Temporal transition of used analysis template

(5) Temporal transition of related event (control signal and process)

Further, the following information is obtained based on these temporal transitions.

(6) Group of information observed based on temporal density

The group of information observed based on a temporal density is operation data used within a certain time range, and is typically a plurality of pieces of operation data activated by a user (person involved in operation) at the same time. In FIG. 5, the group is shown as a rectangle over the plurality of temporal transitions.

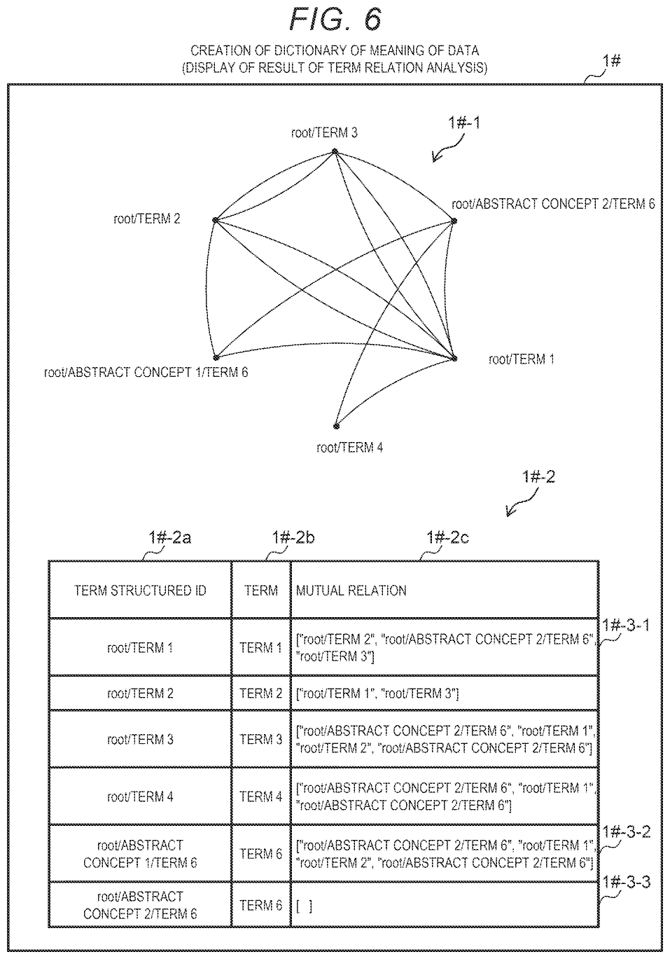

FIGS. 6 to 8 are explanatory diagrams for creating a dictionary of the meaning of data.

FIG. 6 shows the display of a result of a term relation analysis.

A graph 1#-1 is visualized by linking to the structured IDs that have mutual relations. A method of extracting the mutual relations will be described later.

A table 1#-2 displays a term structured ID 1#-2a, a term 1#-2b, and a mutual relation 1#-2c in association with each other.

For example, a row 1#-3-1 of the table 1#-2 indicates that “root/term 1” has a mutual relation with “root/term 2”, “root/abstract concept 2/term 6”, and “root/term 3”.

As shown in a row 1#-3-2, a mutual relation is formed even in different concepts if the same expression has the same meaning. In contrast, as shown in a row 1#-3-3, no mutual relation is formed in different concepts if the same expression has different meanings.

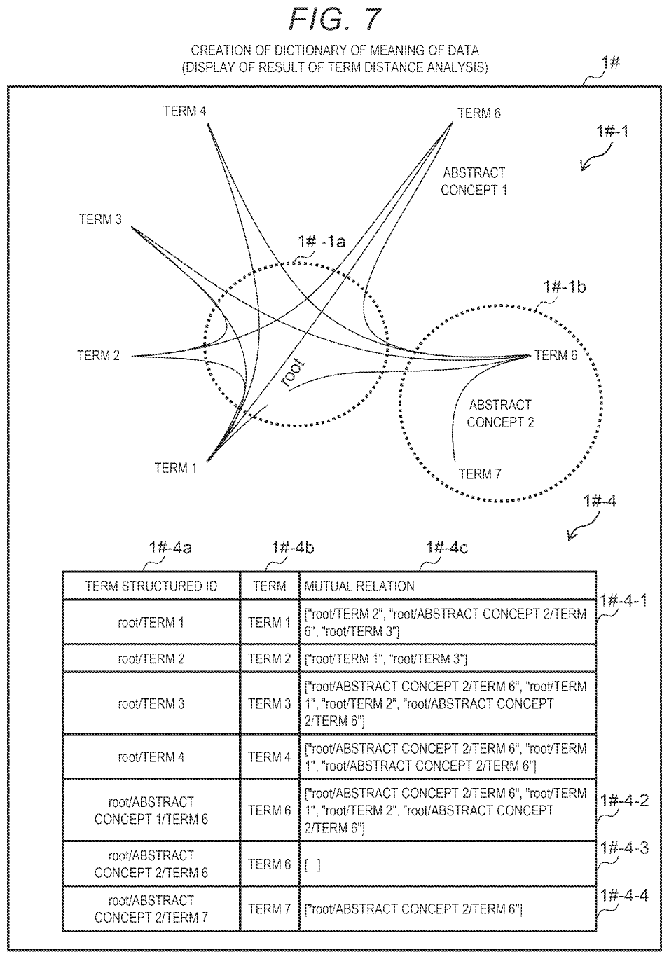

FIG. 7 shows the display of a result of a term distance analysis.

For example, as shown in a graph 1#-1a, a row 1#-4-1 and a row 1#-4-2 are found to have a relation beyond a branch ID. In contrast, as shown in a graph 1#-1b, a row 1#-4-3 and a row 1#-4-4 are found to have a relation only in the abstract concept 2.

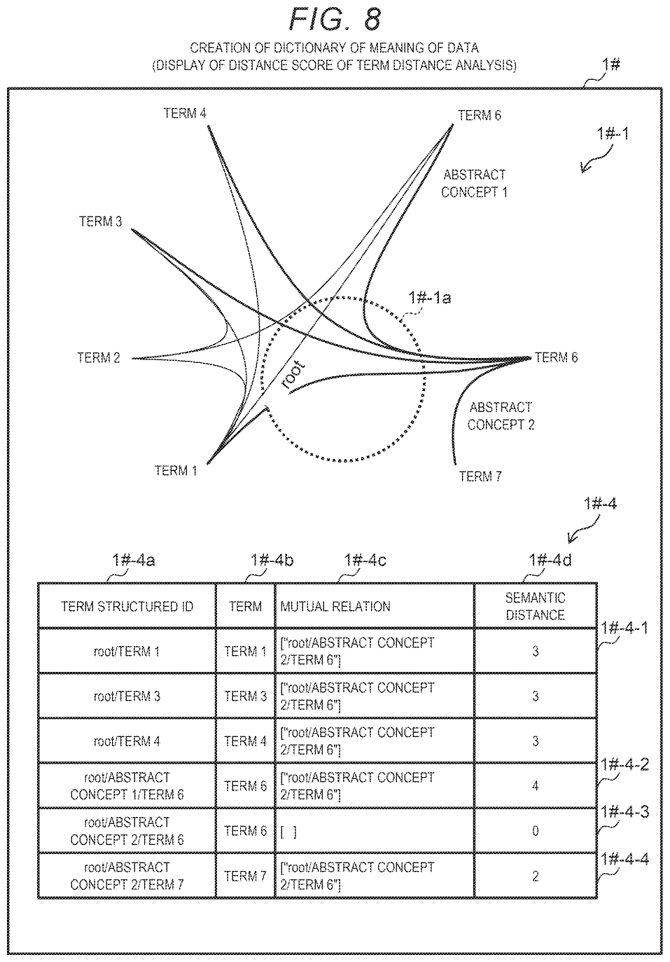

FIG. 8 shows the display of a distance score in the term distance analysis.

In FIG. 8, a column of a semantic distance 1#-4din the case of itself (for example, the row 1#-4-3). In the general concept, a branch is shorter, and for example, the semantic distance is “3” in the row 1#-4-1. The distance in the row 1#-4-2 beyond the abstract concept is “4”. In the same abstract concept, that is, in the row 1#-4-4 which is a semantic relation in a small range, the distance is “1”.

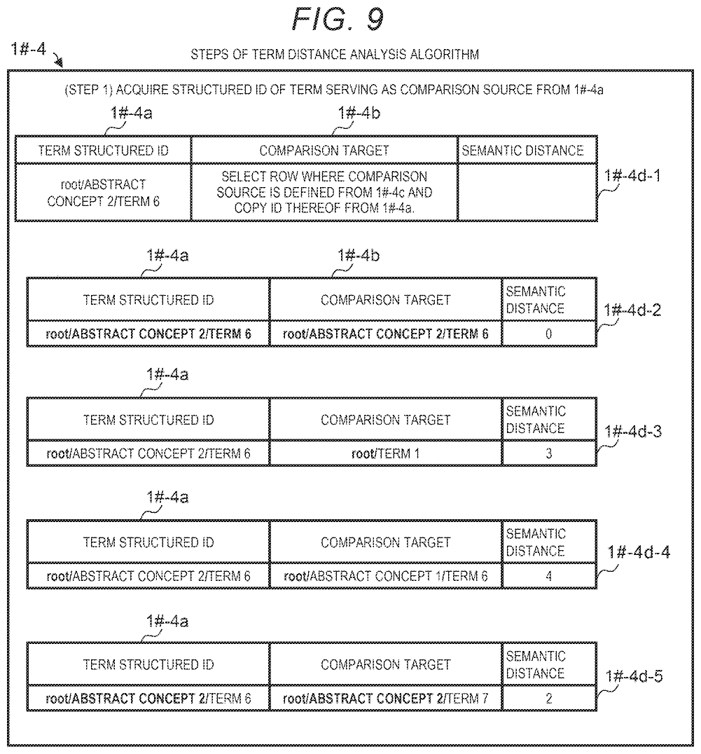

FIG. 9 is an explanatory diagram of steps of a term distance analysis algorithm.

First, in step 1, the server 3 acquires structured IDs of terms serving as comparison sources from 1#-4a. Specifically, as shown in a row 1#-4d-1, a row in which a comparison source is defined is selected from 1#-4c, and an ID thereof is copied from 1#-4a.

Next, in step 2, the server 3 compares the structured IDs.

Condition: If <the same structured ID as the comparison source> is satisfied, the semantic distance is set to “0” as shown in a row 1#-4d-2.

Condition: In <a case of having a common parent and having different individual elements>, a moving distance to the common parent and to a target term is measured. At this time, the distance to a parent ID is set to 1.

As a result, as shown in a row 1#-4d-3, the distance is “3” when “root/abstract concept 2/term 6” and “root/term 1” are compared with each other.

As shown in a row 1#-4d-4, the distance is “4” when “root/abstract concept 2/term 6” and “root/abstract concept 1/term 6” are compared with each other.

As shown in a row 1#-4d-5, the distance is “2” when “root/abstract concept 2/term 6” and “root/abstract concept 2/term 7” are compared with each other.

By this analysis, the server 3 performs the following evaluation.

(1) A relation in which a hierarchy of a structured ID is deep and the semantic distance is short is recognized only in a very limited world, and is the meaning of data that is not used.

(2) A relation in which a hierarchy of a structured ID is deep and the semantic distance is long is the meaning of data that is widely recognized and has a high value. A deep hierarchy suggests that the degree of relevance to a specific operation is high, and a long distance, in particular, a relation beyond another abstract concept suggests that there is relevance to other operations. Therefore, when a depth of the hierarchy and a length of the distance are compatible with each other, the data can be considered to be important data that is deeply related to the specific operation and is also related to other operations.

(3) A relation in which a hierarchy of a structured ID is shallow and is used many times regardless of the semantic distance is the meaning of data that is widely and generally recognized (formed into a template).

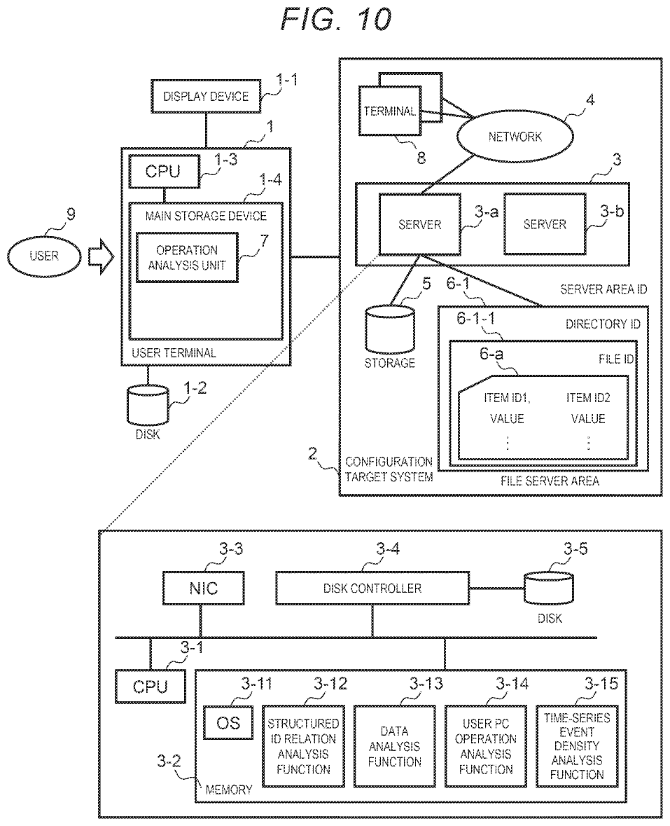

FIG. 10 is a configuration diagram in a case of analyzing an operation of a user. Compared to the configuration shown in FIG. 1, the configuration shown in FIG. 10 further includes an operation analysis unit 7 in the main storage device 1-4 of the user terminal 1. The server 3 is connected to a plurality of terminals 8 via a network 4, and the memory 3-2 is further provided with the user PC operation analysis function 3-14 and the time-series event density analysis function 3-15. Since other configurations are the same as those in FIG. 1, the same components are denoted by the same reference numerals, and the description thereof will be omitted.

In the present configuration, the user terminal 1 is used by a user who is a data administrator having an authority for analysis, whereas the terminal 8 is used by a user as a person involved in operation who does not have an authority for analysis and stores and uses the operation data.

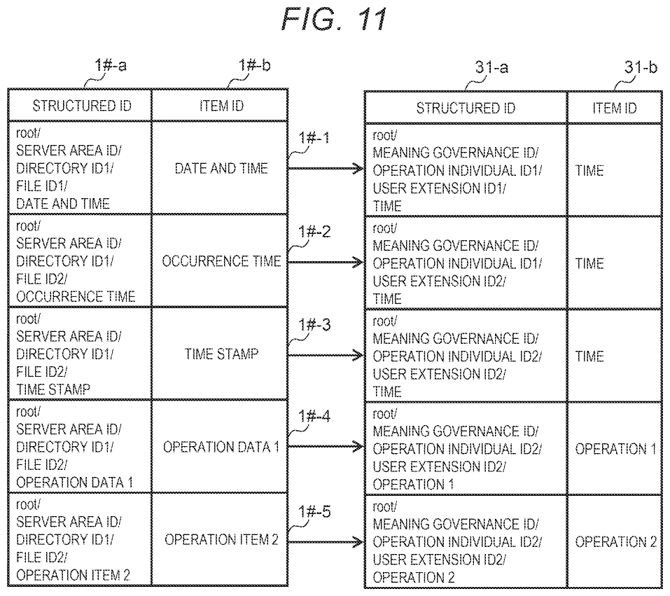

FIG. 11 is an explanatory diagram of redefinition of a structured ID based on an implementation-dependent semantic hierarchy.

FIG. 11 shows a table relation for newly defining a semantic hierarchy to be published with reference to a semantic hierarchy in an implementation-dependent file server area.

Structured IDs and item IDs created by taking a meaning narrowing concept in an implementation environment are defined by a user (person involved in operation). From the structured IDs and item IDs, a structured ID for publication is defined and published by selecting for the purpose of sharing the meaning of data or by creating a new one.

For example, items related to time such as “date and time”, “occurrence time”, and “time stamp” are unified to “time”, and inconsistent notations such as “operation data <number>” and “operation item <number>” are also unified to the notation of “operation <number>”.

Further, by specifying a predetermined value for a directory name or the like used for a structured ID in accordance with employment of a system or by allowing a user (person involved in operation) to make any settings, it is possible to improve convenience and flexibility.

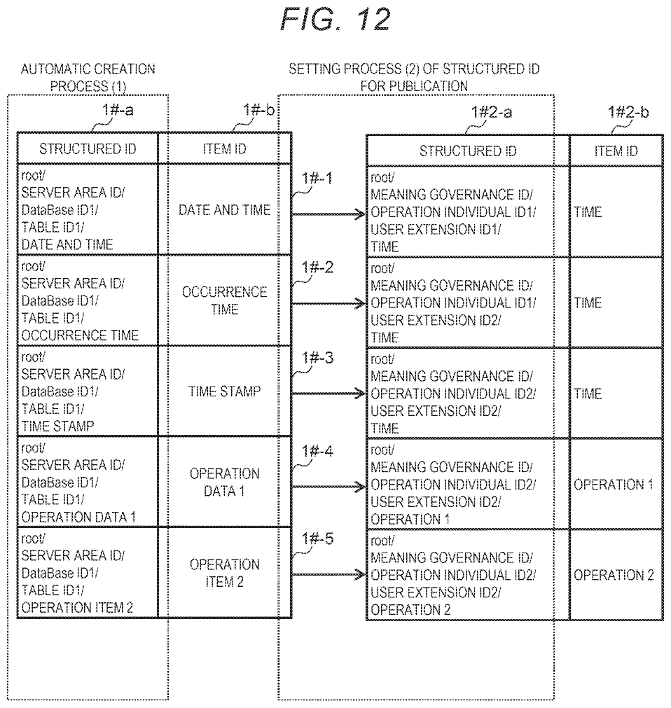

FIG. 12 is an explanatory diagram of redefinition of a structured ID based on a semantic hierarchy of a database.

FIG. 12 shows a table relation for newly defining a semantic hierarchy to be published with reference to a semantic hierarchy in a file server area of the database.

Structured IDs and item IDs created by taking a meaning narrowing concept in the database are based on an automatic creation process of the database. From the structured IDs and item IDs, a structured ID for publication is defined and published by selecting for the purpose of sharing the meaning of data or by creating a new one.

Specifically, similar to FIG. 11, convenience and flexibility can be improved by unifying the items and setting the structured IDs.

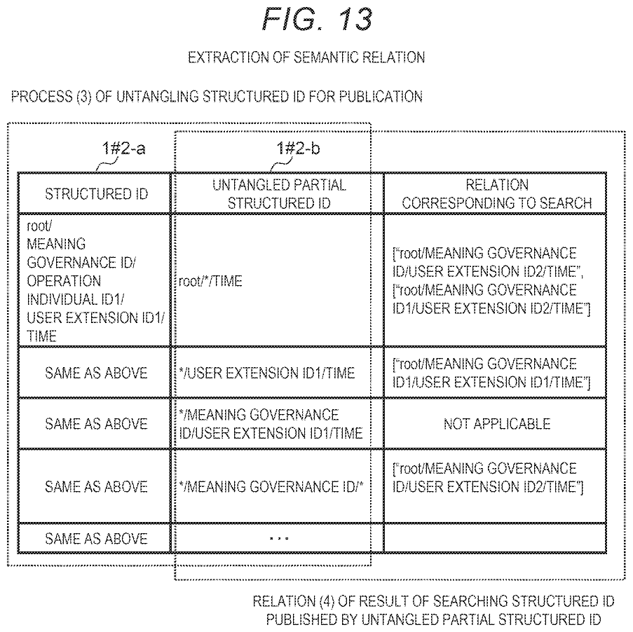

FIG. 13 is an explanatory diagram of extraction of a semantic relation.

The structured ID relation analysis function 3-12 of the server 3 extracts a semantic relation by performing a process of untangling the structured ID for publication and searching for a structured ID published by the untangled partial structured ID.

The process of untangling the structured ID for publication is performed by replacing a part of each hierarchy of the structured ID with a wild card. By replacing a part of the structured ID with a wild card, a plurality of the untangled partial structured IDs can be obtained. The structured ID relation analysis function 3-12 searches for a published structured ID by using each of the partial structured IDs. As a result, a structured ID partially matching the original structured ID is extracted, and the extracted structured ID is a structured ID related to the original structured ID.

If the search result here is “not applicable”, it indicates that there is no such a usage. If there are too many search results, it indicates that the meaning is too wide. If there is only one search result, it indicates that there is a sufficient amount of information and that one word alone can provide a common understanding.

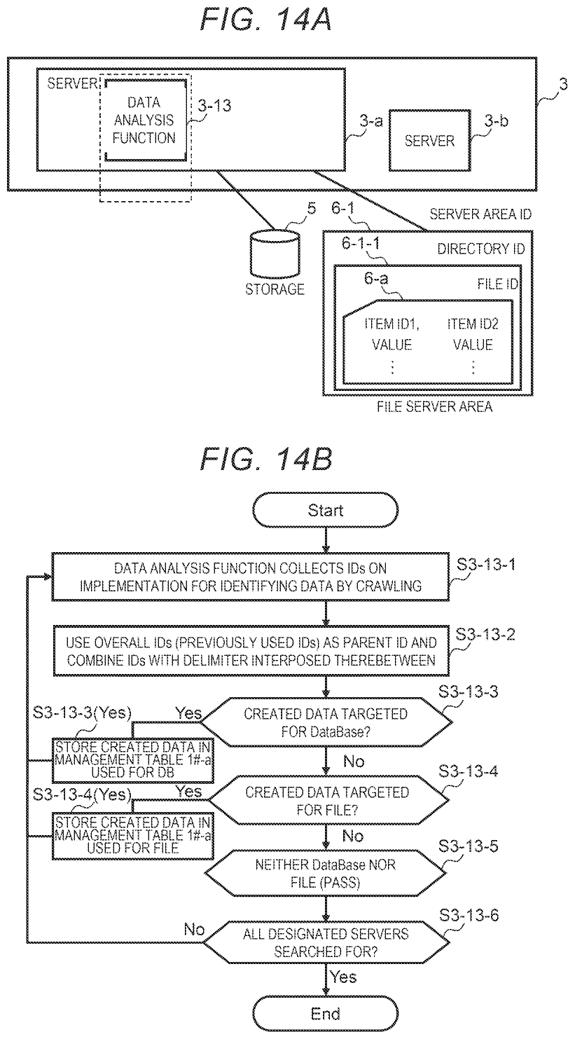

FIGS. 14A and 14B show a procedure for generating a structured ID.

The data analysis function 3-13 of the server 3 generates, based on implementation-dependent information, a non-collision structured ID including a thinking order of a customer.

Specifically, the data analysis function 3-13 sequentially execute the processes of the following steps S3-13-1 to S3-13-6.

### Step S3-13-1

The data analysis function 3-13 collects IDs on implementation for identifying data by crawling. Thereafter, the process proceeds to step S3-13-2.

### Step S3-13-2

The data analysis function 3-13 uses, as a parent ID, overall IDs (previously used IDs), and combines the IDs with a delimiter interposed therebetween. Thereafter, the process proceeds to step S3-13-3.

### Step S3-13-3

The data analysis function 3-13 determines whether the created data is targeted for a database. If the created data is a database (Yes) , the created data is stored in a DB management table, and the process proceeds to step S3-13-1. If the created data is not a database (No), the process proceeds to step S3-13-4.

### Step S3-13-4

The data analysis function 3-13 determines whether the created data is targeted for a file. If the created data is a file (Yes), the created data is stored in a file management table, and the process proceeds to step S3-13-1. If the created data is not a file (No), the process proceeds to step S3-13-5.

### Step S3-13-5

When the process proceeds to this step, the created data is neither a database nor a file. The data analysis function 3-13 proceeds to step S3-13-6 without storing data.

### Step S3-13-6

The data analysis function 3-13 determines whether all designated servers are searched for. If there is an unsearched server (No), the process proceeds to step S3-13-1. If all the servers are searched for (Yes), the process ends.

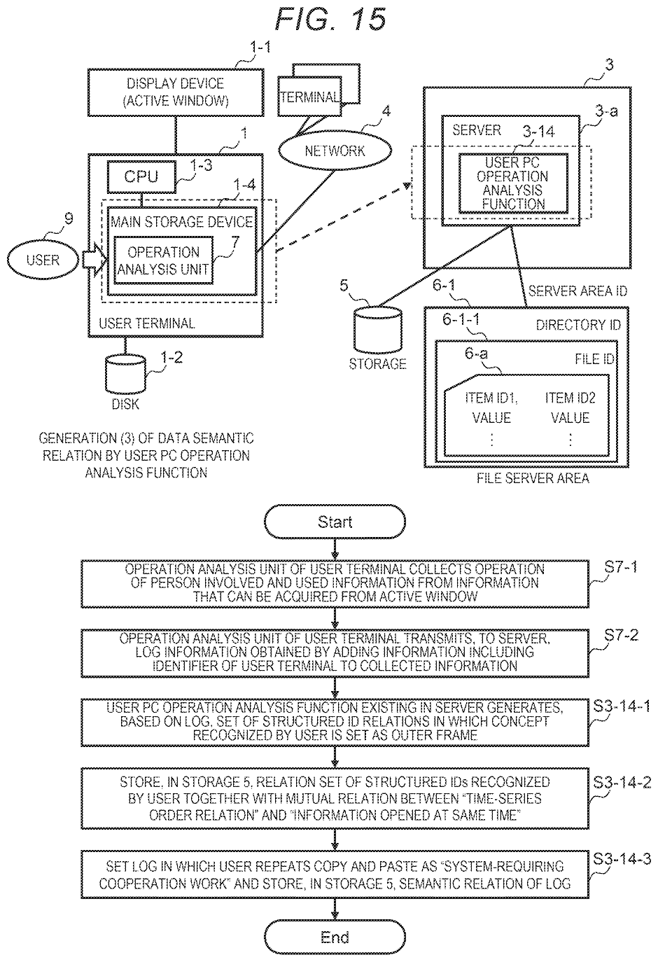

FIG. 15 is a flowchart of generation of a data semantic relation based on an operation of a user.

First, the operation analysis unit 7 of the user terminal 1 collects an operation of a user (person involved in operation) and used information from information that can be acquired from an active window (step S7-1). Next, the operation analysis unit 7 transmits, to the server 3, log information obtained by adding information including an identifier of a user terminal to the collected information (step S7-2).

Thereafter, the user PC operation analysis function 3-14 existing in the server 3 generates, based on the log, a set of structured ID relations in which a concept recognized by the user (person involved in operation) is set as an outer frame (step S3-14-1).

Then, the user PC operation analysis function 3-14 stores, in the storage 5, the relation set of the structured IDs recognized by the user (person involved in operation) together with a mutual relation between a “time-series order relation” and “information opened at the same time” (step S3-14-2).

Further, the user PC operation analysis function 3-14 sets a log in which the user (person involved in operation) repeats copy and paste as a “system-requiring cooperation work”, and stores, in the storage 5, a semantic relation of the log.

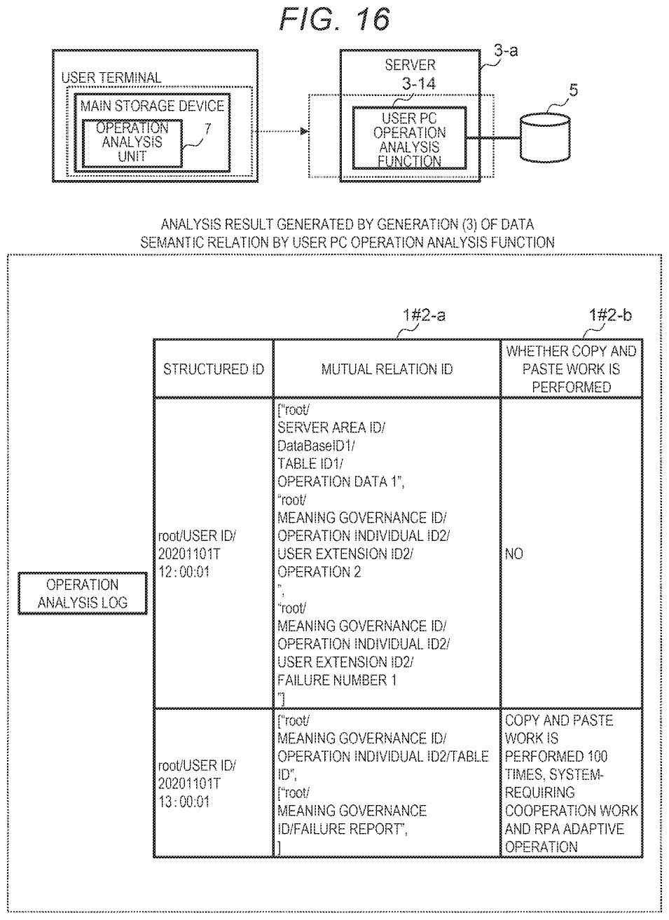

FIG. 16 is an explanatory diagram of a generation result of the data semantic relation based on an operation of the user.

As shown in FIG. 16, in an operation analysis log obtained by generating the data semantic relation based on an operation of the user, time information is added to a structured ID. The information opened at the same time is registered in the mutual relation ID. Whether the copy and paste work is performed is registered.

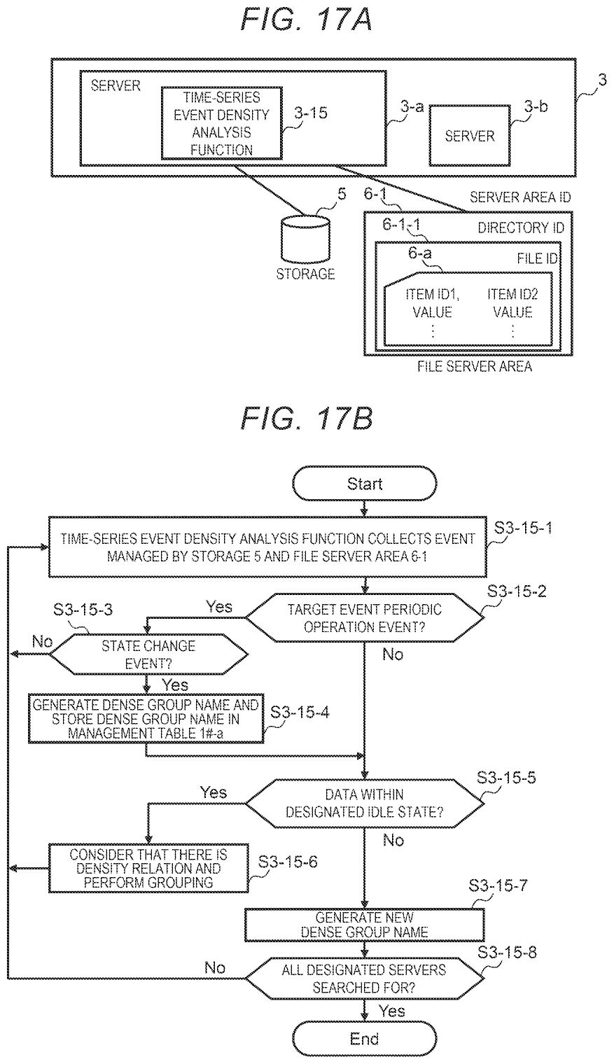

FIGS. 17A and 17B show a procedure for analyzing a density.

The time-series event density analysis function 3-15 of the server 3 sequentially executes processes of the following steps S3-15-1 to S3-15-8 in order to analyze relations between pieces of information generated at a density beyond human capabilities.

### Step S3-15-1

The time-series event density analysis function 3-15 collects events managed by the storage 5 and the file server area 6-1. Thereafter, the process proceeds to step S3-15-2.

### Step S3-15-2

The time-series event density analysis function 3-15 determines whether a target event is a periodic operation event. If the target event is the periodic event (Yes), the process proceeds to step S3-15-3. If the target event is not the periodic event (No) , the process proceeds to step S3-15-5.

### Step S3-15-3

The time-series event density analysis function 3-15 determines whether a target event is a state change event. If the target event is the state change event (Yes), the process proceeds to step S3-15-4. If the target event is not the state change event (No), the process proceeds to step S3-15-1.

### Step S3-15-4

The time-series event density analysis function 3-15 generates a dense group name and stores the dense group name in a management table 1#-a. Thereafter, the process proceeds to step S3-15-5.

### Step S3-15-5

The time-series event density analysis function 3-15 determines whether the data is within a designated idle state. If the data is within the designated idle state (Yes), the process proceeds to step S3-15-6. If the data is not within the designated idle state (No), the process proceeds to step S3-15-7.

### Step S3-15-6

The time-series event density analysis function 3-15 considers that there is a density relation and performs grouping. Thereafter, the process proceeds to step S3-15-1.

### Step S3-15-7

The time-series event density analysis function 3-15 generates a new dense group name. Thereafter, the process proceeds to step S3-15-8.

### Step S3-15-8

The time-series event density analysis function 3-15 determines whether all designated servers are searched for. If there is an unsearched server (No), the process proceeds to step S3-15-1. If all the servers are searched for (Yes), the process ends.

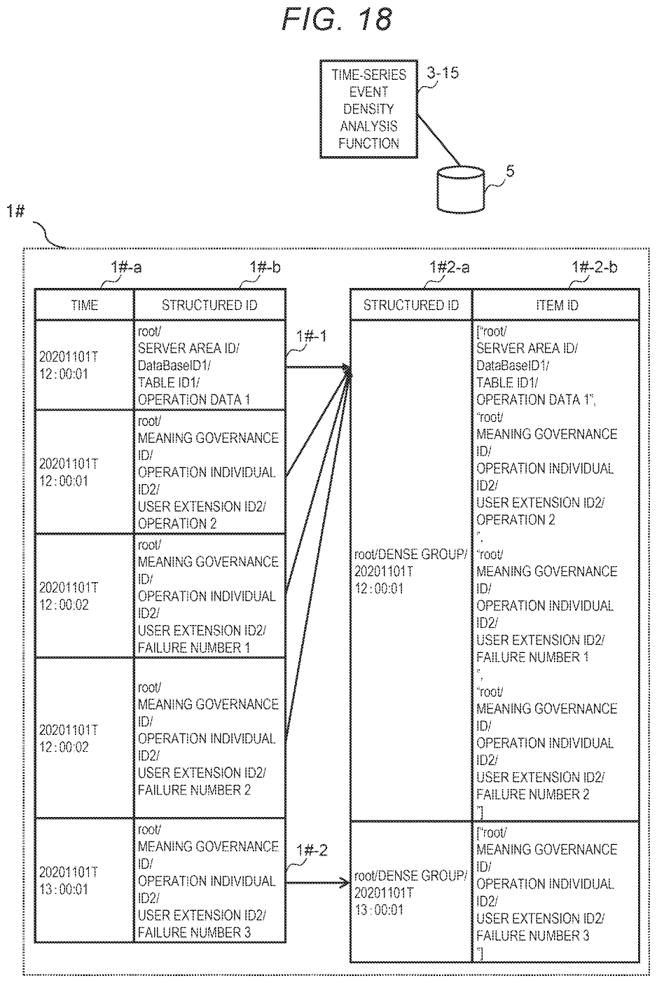

FIG. 18 is an explanatory diagram of an analysis result of the density.

In FIG. 18, structured IDs of time “20201101T 12:00:01” to time “20201101T 12:00:02” are considered to be used at the same time, and are included in one dense group “root/dense group/20201101T 12:00:01”. A structured ID of time “20201101T 13:00:01” is set as another dense group “root/dense group/20201101T 13:00:01”.

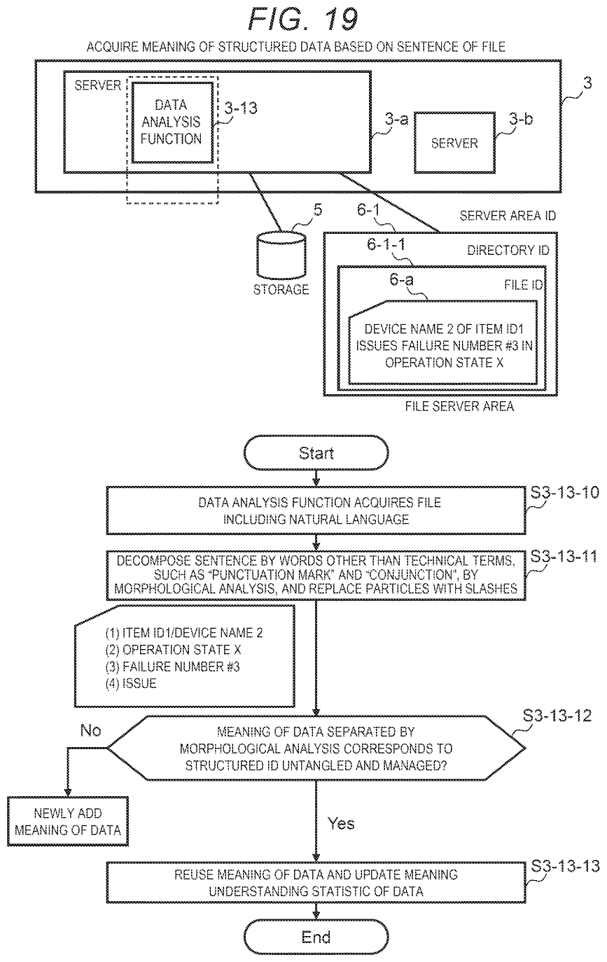

FIG. 19 is a flowchart showing a procedure for acquiring the meaning of structured data based on a sentence of a file.

The data analysis function 3-13 of the server 3 sequentially executes processes of the following steps S3-13-10 to S3-13-13.

### Step S3-13-10

The data analysis function 3-13 acquires a file including the natural language. Thereafter, the process proceeds to step S3-13-11. For example, the acquired file includes a sentence such as “the device name 2 of the item ID1 issues the failure number #3 in the operation state X”.

### Step S3-13-11

The data analysis function 3-13 decomposes the sentence by words other than technical terms, such as a “punctuation mark” and “conjunction”, by morphological analysis, and replaces a connection relation of terms with slashes. Thereafter, the process proceeds to step S3-13-12. In the process of replacing the connection relation of terms with slashes, for example, the case particle “and” in Japanese may be replaced with a slash. As a result of this step, data such as “item ID1/device name 2”, “operation state X”, “failure number #3”, and “issues” is obtained.

### Step S3-13-12

The data analysis function 3-13 determines whether the meaning of the data separated by the morphological analysis corresponds to a structured ID which is untangled and managed. If the meaning of the data does not correspond to the structured ID (No), the data analysis function 3-13 newly adds the meaning of the data. If the meaning of the data corresponds to the structured ID (Yes), the process proceeds to step S3-13-13.

### Step S3-13-13

The data analysis function 3-13 reuses the meaning of the data, updates a meaning understanding statistic of the data, and ends the process.

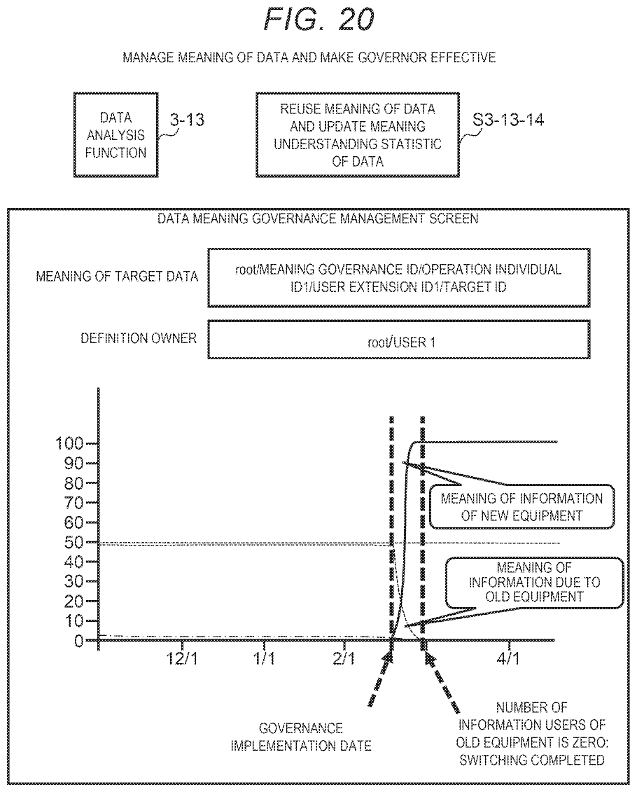

FIGS. 20 to 22 are explanatory diagrams of governance management of the meaning of data.

In FIGS. 20 to 22, the data analysis function 3-13 reuses the meaning of data and updates a meaning understanding statistic of the data (step S3-13-14).

In FIG. 20, equipment is replaced in February of a certain year, and governance is implemented so as to use terms corresponding to the new equipment. As a result, a frequency of use of the meaning of information due to the old equipment decreases from a governance implementation date, and the frequency of use of the meaning of information of the new equipment increases. Then, at a certain point in time, the number of information users of the old equipment is zero, and switching is completed.

As described above, in the display of an analysis result of FIG. 20, it is possible to identify and visualize the replacement of operation data used with the same meaning.

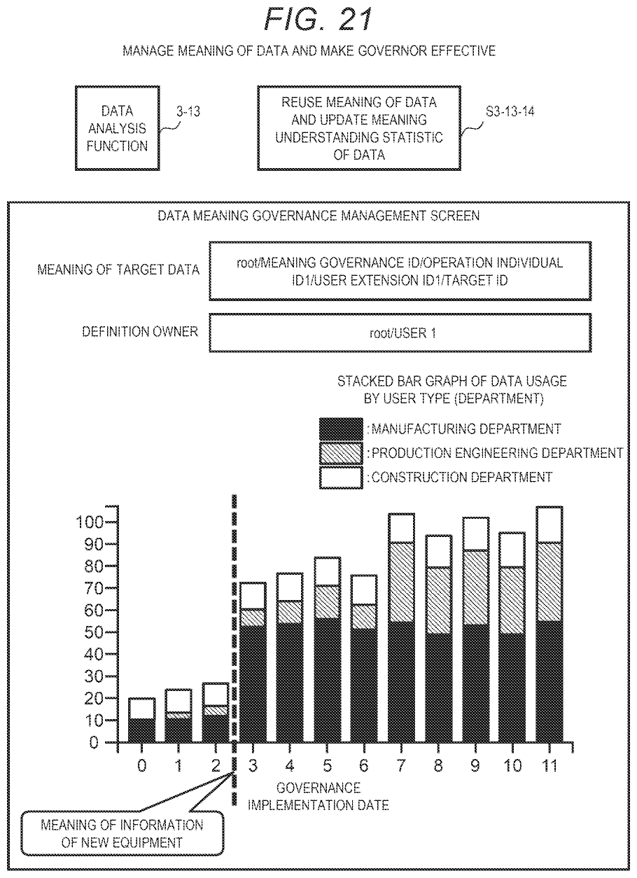

In FIG. 21, equipment is replaced in February of a certain year, and governance is implemented so as to use terms corresponding to the new equipment. As a result, the frequency of use of the meaning of information of the new equipment greatly increases from a governance implementation date in a manufacturing department, the frequency of use of the meaning of the information of the new equipment is gradually increased in a production engineering department, and an increase in the frequency of use of the meaning of the information of the new equipment in a construction department is further gentle. When this change is analyzed, it can be pointed out that the frequency of use increases first in the manufacturing department and then increases in other departments, and therefore it may be important words that everyone uses for consensus building.

As described above, in the display of an analysis result of FIG. 21, it is possible to visualize the transition of the frequency of use of the terms by comparing the transition for each department.

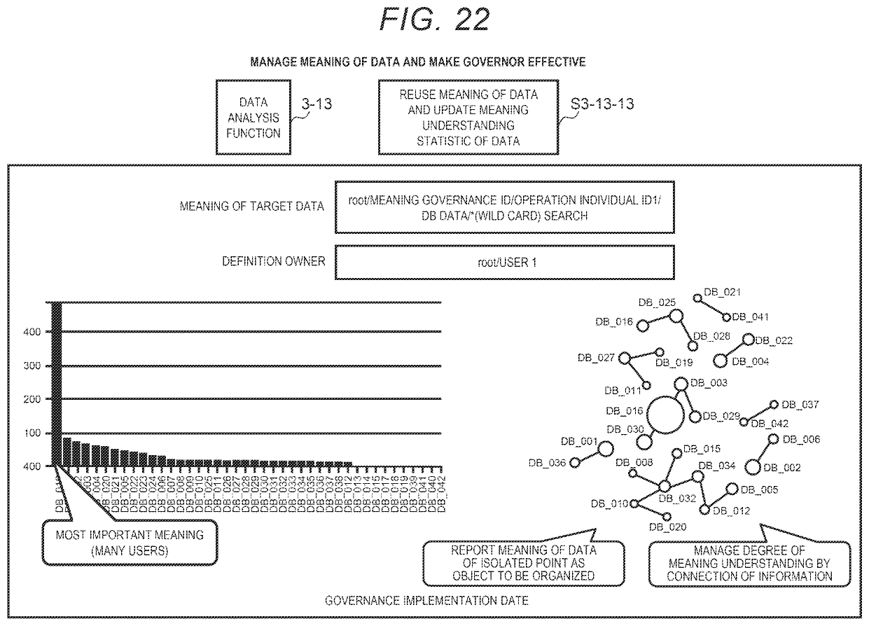

In FIG. 22, the frequency of use of terms is compared by a histogram, and relations between the terms is displayed as a graph. For example, a term having a large histogram value can be evaluated as a term that is used by many users and has an important meaning.

In the graph, the frequency of use of a term is indicated as a size of a circle, and the relations between the terms is indicated as a link. The meaning of data isolated in the graph can be set as an object to be organized. A degree of understanding of the meaning can be managed by connection of information. The larger the circle is, and the larger the number of links is, the more valuable the data is. The value is, for example, a value in the performance of an operation, such as “knowledge of the word is important for understanding an operation” or “knowing the word allows a user to converse with the department”.

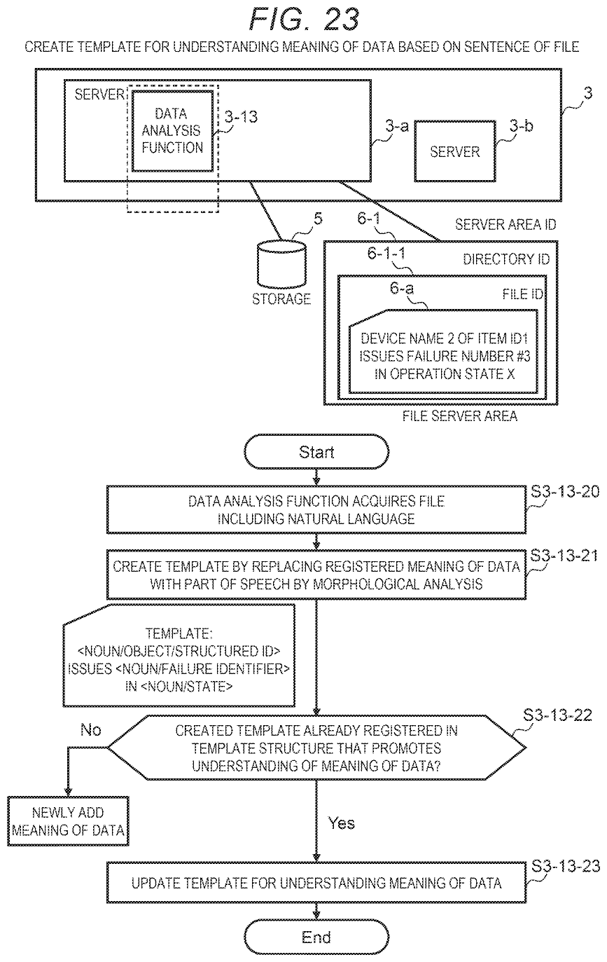

FIG. 23 is a flowchart showing a procedure for creating a template for understanding the meaning of data.

The data analysis function 3-13 of the server 3 sequentially executes processes of the following steps S3-13-20 to S3-13-23.

### Step S3-13-20

The data analysis function 3-13 acquires a file including natural language. Thereafter, the process proceeds to step S3-13-21. For example, the acquired file includes a sentence such as “the device name 2 of the item ID1 issues the failure number #3 in the operation state X”.

### Step S3-13-21

The data analysis function 3-13 creates a template by replacing registered meaning of data with a part of speech by morphological analysis. Thereafter, the process proceeds to step S3-13-22. As a result of this step, a template such as “the <noun/object/structured ID> issues the <noun/failure identifier> in the <noun/state>” is obtained.

### Step S3-13-22

The data analysis function 3-13 determines whether the created template is already registered in a template structure that promotes understanding of the meaning of data. If the template is not registered (No), the data analysis function 3-13 newly adds the meaning of data. If the template is registered (Yes), the process proceeds to step S3-13-23.

### Step S3-13-23

The data analysis function 3-13 updates the template for understanding the meaning of data and ends the process.

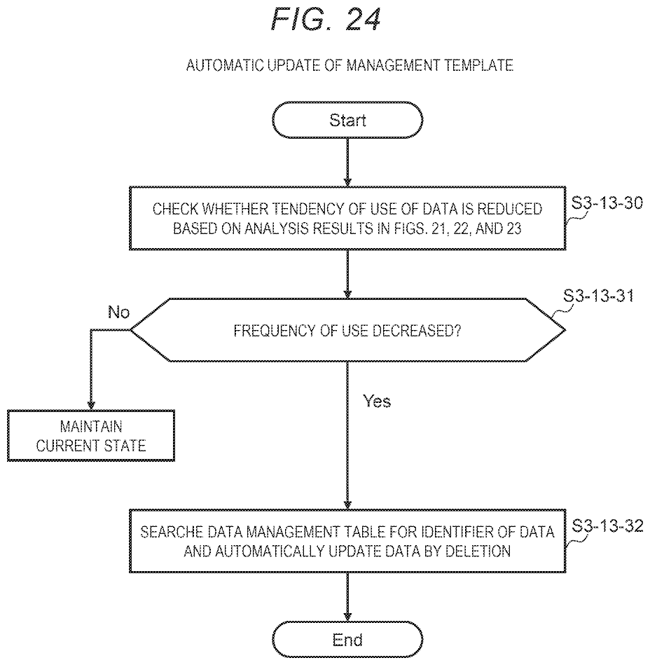

FIG. 24 is a flowchart showing a procedure for automatically updating a management template.

The data analysis function 3-13 of the server 3 sequentially executes processes of the following steps S3-13-30 to S3-13-32.

### Step S3-13-30

The data analysis function 3-13 checks whether tendency of use of data is reduced based on the analysis results in FIGS. 21 to 23. Thereafter, the process proceeds to step S3-13-31.

### Step S3-13-31

The data analysis function 3-13 determines whether the frequency of use is decreased. If the frequency of use is not decreased (No), the current state is maintained. If the frequency of use is decreased (Yes), the process proceeds to steps S3-13-32.

### Step S3-13-32

The data analysis function 3-13 searches a data management table for an identifier of the data, automatically updates the data by deletion, and ends the process.

As described above, the operation data analysis system including the server 3 as the operation data analysis device includes the CPU 3-1 as an arithmetic device and the storage 5 as a storage device. The storage device stores the management target data including the operation data which is data related to an operation. The arithmetic device analyzes how the operation data is used in the operation by using the operation data included in the management target data and the operation data used in a structure related to management of the management target data.

Therefore, the operation data can be analyzed at a higher level.

The operation data is a term used for the operation. The management target data is stored in a directory having a hierarchical structure. The arithmetic device uses a name of the directory as the operation data and uses the hierarchical structure as the hierarchized identification information to create the dictionary of a meaning of the term.

Therefore, the operation data can be analyzed at a high level considering that a term used for the name of the directory is recognized as clear and versatile for a person involved in the operation. That is, by collecting data including a directory structure, it is possible to collect a human concept and grouping for identifying the data and an identification name for realizing a hierarchical structure and communication, and to include the human concept and grouping and the identification name in an analysis target.

The arithmetic device compares the identification information to obtain, as a distance, a difference in the hierarchical structure, and evaluates a relation between the operation data.

For example, the arithmetic device evaluates that operation data having a relation in which a hierarchy is deep and the distance is small is used in a limited range, evaluates that operation data having a relation in which the hierarchy is deep and the distance is large is widely recognized and has a high value in the operation, and evaluates that operation data, which has a shallow hierarchy and is used many times regardless of the distance, is a widely recognized general term.

Therefore, it is possible to identify whether the data is a local term or has a meaning beyond a concept from a relation between the distance and the hierarchy, and to analyze the operation data at a high level.

The management target data is sentence data described in natural language using a term as the operation data, and the arithmetic device can create a template that promotes understanding the meaning of the operation data by generalizing the term of the sentence data.

Therefore, the operation data can be analyzed at a high level based on a sentence such as a manual.

The arithmetic device can acquire a behavior of a user who operates the operation data and associate a plurality of pieces of operation data based on the behavior.

For example, the arithmetic device sets a plurality of pieces of operation data activated by the user at the same time as related operation data.

Therefore, it is possible to collect the locality of what the user is using at one time as the behavior of the user, and perform analysis at a high level in association with the operation data. For example, even though the distance between the terms is long, it is possible to analyze terms that are used at the same timing from the viewpoint of being a group of words that are important for communication.

The arithmetic device statistically analyzes a result of use of the operation data, and identifies replacement of operation data used for the same meaning.

Therefore, it is possible to perform the analysis on an actual state of use of the operation data at a high level.

The invention is not limited to the above-described embodiment, and includes various modifications. For example, the embodiment described above has been described in detail for easy understanding of the invention, and the invention is not necessarily limited to those including all of the configurations described above. The configuration is not limited to being deleted, and the configuration may be replaced or added.

What is claimed is:

1. An operation data analysis device comprising:
an arithmetic device; and
a storage device, wherein
the storage device stores management target data including operation data which is data related to an operation, and
the arithmetic device analyzes how the operation data is used in the operation by using the operation data included in the management target data and operation data used in a structure related to management of the management target data.

2. The operation data analysis device according to claim 1, wherein
the operation data is a term used for the operation,
the management target data is stored in a directory having a hierarchical structure, and
the arithmetic device uses a name of the directory as the operation data and uses the hierarchical structure as hierarchized identification information to create a dictionary of a meaning of the term.

3. The operation data analysis device according to claim 2, wherein
the arithmetic device compares the identification information to obtain, as a distance, a difference in the hierarchical structure, and evaluates a relation between the operation data.

4. The operation data analysis device according to claim 3, wherein
the arithmetic device evaluates that operation data having a relation in which a hierarchy is deep and the distance is small is used in a limited range, evaluates that operation data having a relation in which the hierarchy is deep and the distance is large is widely recognized and has a high value in the operation, and evaluates that operation data, which has a shallow hierarchy and is used many times regardless of the distance, is a widely recognized general term.

5. The operation data analysis device according to claim 1, wherein
the management target data is sentence data described in natural language using a term as the operation data, and
the arithmetic device creates a template that promotes understanding a meaning of the operation data by generalizing a term of the sentence data.

6. The operation data analysis device according to claim 1, wherein
the arithmetic device acquires a behavior of a user who operates the operation data and associates a plurality of pieces of operation data based on the behavior.

7. The operation data analysis device according to claim 6, wherein
the arithmetic device sets a plurality of pieces of operation data activated by the user at the same time as related operation data.

8. The operation data analysis device according to claim 1, wherein
the arithmetic device statistically analyzes a result of use of the operation data, and identifies replacement of operation data used for the same meaning.

9. An operation data analysis system comprising:
an arithmetic device; and
a storage device, wherein
the storage device stores management target data including operation data which is data related to an operation, and
the arithmetic device analyzes how the operation data is used in the operation by using the operation data included in the management target data and operation data used in a structure related to management of the management target data.

10. An operation data analysis method comprising:
by an arithmetic device,
a step of storing, in a storage device, management target data including operation data which is data related to an operation;
a step of analyzing how the operation data is used in the operation by using the operation data included in the management target data and operation data used in a structure related to management of the management target data; and
a step of outputting an analysis result.
